(19) United States
(12) Patent Application Publication
(10) Pub. No.: US 2026/0060160 A1
(43) Pub. Date: Mar. 5, 2026

(54) Hoeing device intended to be towed, comprising a deformable parallelogram carrying at least one hoeing element

(71) Applicant: BINNOVE, LAYRAC (FR)

(72) Inventor: Jansingh Nicolaas, Sempesserre (FR)

(21) Appl. No.: 19/314,004

(22) Filed: Aug. 29, 2025

(30) Foreign Application Priority Data
Sep. 2, 2024 (FR) FR2409329

(51) Int. Cl. A01B 19/02; A01B 15/02; A01B 23/04

(52) U.S. Cl. CPC A01B 19/02; A01B 15/02; A01B 23/043

(57) ABSTRACT

A hoeing device includes: a frame intended to be coupled to a vehicle for towing the hoeing device; and a deformable parallelogram having comprising an upper beam and a lower beam carrying at least one hoeing tool as well as an element for running on the ground. The beams being connected by at least one pair of connecting rods, the connecting rods extending from one beam to the other while being inclined, from the upper beam to the lower beam, forwards in a forward direction of movement of the hoeing device. A connecting member is inserted between the frame and the deformable parallelogram.

### CROSS-REFERENCE TO RELATED APPLICATIONS

This Application claims priority to and the benefit of French Patent Application No. FR2409329, filed Sep. 2, 2024, the content of which is incorporated herein by reference in its entirety.

### TECHNICAL FIELD

The field of the disclosure is that of the design and manufacture of agricultural machines. More specifically, the disclosure relates to a hoeing device intended to be towed by a vehicle, designed in particular but not exclusively for working hard soil.

### PRIOR ART

Weeding is a weeding operation in the vicinity of crops, aimed at promoting the development of said crops, by eliminating the parasitic capture of water by weeds and optimizing the penetration of water into the soil towards the roots of the crops.

For agriculture, hoeing equipment has been developed to be specifically adapted to crops sown in-line (porn, beet, etc.), allowing hoeing to be carried out between rows of plants newly emerged from the ground, optionally simultaneously between several rows of plants.

A distinction is made between two main types of hoeing machines, tine hoes and star hoes. In both cases, the principle is the same: hoeing elements work between the crop lines so as to penetrate the soil a few centimeters, in order to pass under the roots or through them and pull out the weeds, leaving a series of furrows behind the passage of the hoeing machine.

In some cases, the hoeing work is made particularly difficult, either due to the hardness of the soil (particularly dry soil) or due to the presence of stones.

However, in the presence of such hard soils, the main difficulty is to be able to keep the hoeing elements in the soil, whereas these naturally tend to move away from it, due to an upward retraction of the hoeing device.

This is because, according to a conventional design of the hoeing machines, the hoeing elements are carried by the lower (horizontal) beam of a deformable parallelogram, the lower beam being connected to the upper beam of the parallelogram by two connecting rods inclined forwards (in the direction of movement of the hoeing machine), going from the lower beam to the upper beam.

In practice, with such a design, when the hoeing machine encounters a restriction or an obstacle, the hoeing elements exert a backward force on the lower beam, which tends to tilt backward relative to the upper beam, resulting in an upward movement of the hoeing elements (hence their removal from the ground). On a kinematics level, this is explained by the fact that the upper end of the connecting rods is secured on the upper beam, while constituting a pivot axis about which the connecting rod rotates in an arc-of-circle movement.

To avoid this retraction phenomenon, a common technique is to weigh down the parallelogram of the hoeing machine to keep the tines in the soil.

This technique is not always fully satisfactory, and in any case finds its limits on particularly hard soils.

To solve this problem, and to allow the hoeing elements to be kept in the soil under all circumstances, in particular when working on hard ground, the solution described in the invention patent published under number EP2880969 was proposed. In this solution, the orientation of the connecting rods connecting the upper beam to the lower beam of the parallelogram is reversed compared with that of the technique described previously. This is because the connecting rods are oriented forward from the upper beam to the lower beam. This causes the parallelogram to react when working on hard ground or in the presence of an obstacle so that the lower beam pivots towards the rear of the device. This pivoting tends to move the lower beam away from the upper beam, resulting in a downward movement of the lower beam, tending to keep the hoeing elements in the soil, or even to slightly increase their penetration distance into the soil.

This solution is particularly satisfactory in terms of the quality of the work provided, and in the dynamic behavior of the hoeing device with regard to its ability to maintain or even strengthen the holding of the hoeing elements in the soil. This solution is also satisfactory in that it has a robust and simple design, minimizing the maintenance required to keep it operational.

Since the proposal of this solution, new needs have emerged, in particular with regard to the possibility of avoiding hoeing of certain areas without having to divert the vehicle equipped with the hoeing device.

### SUMMARY

An exemplary aspect of the present disclosure provides a hoeing device comprising:
a frame intended to be hitched to a vehicle to tow the hoeing device;
a deformable parallelogram comprising an upper beam and a lower beam carrying at least one hoeing tool as well as means for running on the ground, said beams being connected by at least one pair of connecting rods, the connecting rods extending from one beam to the other while being inclined, from the upper beam to the lower beam, forwards in a forward direction of movement of the device,
a connecting member being interposed between the frame and the deformable parallelogram;
characterized in that the upper beam is movable relative to the frame between a position raised towards the frame and a position lowered towards a soil, the upper beam being rotatably mounted on the connecting member about an axis of rotation extending orthogonally to a longitudinal axis of the upper beam and located at a front end of the upper beam, and in that the hoeing device comprises a double-acting hydraulic cylinder comprising a body rotatably mounted on the connecting member and a rod whose distal end is rotatably mounted on an anchor point of the upper beam, the anchor point being located along the upper beam and away from the front end of the upper beam, the hydraulic cylinder being in the extended position in the lowered position of the upper beam.

Thanks to the rotating mounting of the upper beam by its front end on the connecting member, and on the hydraulic cylinder, the deformable parallelogram can be raised, thus retracting the hoeing tool(s) from the ground, by passing the upper beam from its lowered position to its raised position. In this way, when approaching an area where hoeing should not be performed, the user of the device can simply trigger the retraction of the hoeing tools without necessarily having to divert their vehicle.

The forward orientation of the connecting rods from the upper beam to the lower beam tends to cause the parallelogram to react when working on hard ground or in the presence of an obstacle so that the lower beam pivots towards the rear of the device. Such pivoting tends to move the lower beam away from the upper beam, resulting in a downward movement of the lower beam which tends to hold the hoeing elements in the ground, or even slightly increase their penetration distance into the ground. Thus the hoening elements do not withdraw from the soil in the event of hard ground or obstacles but, on the contrary, maintain or even increase their depth level in the soil in the event of appreciable resistance.

The design of the connecting member and of the hydraulic cylinder combines its effects with those of the deformable parallelogram arranged in the manner described above. The combination of these effects makes it possible to obtain an optimized dynamic behavior of the hoeing device with regard to its ability to keep the hoeing tools pressed into the ground. More specifically, the design of the deformable parallelogram creates, during hoeing, a counterforce exerted on the upper beam in a direction going from the front to the rear, with potentially an evolving vertical component depending on the nature of the ground or the presence of an obstacle. The hydraulic cylinder then absorbs part of these forces which could tend to rotate the upper beam about its axis of rotation on the connecting member. The use and integration of the hydraulic cylinder makes it possible to absorb these forces in an optimized manner thanks to its rod which is in its extended position, and therefore abutting, preventing a lowering of the rear end of the upper beam, and which fights against a raising of the rear end of the upper beam thanks to the liquid filling one of the chambers of the cylinder body to keep it in its extended position.

According to a preferred feature, the hydraulic cylinder is rotatably mounted on the connecting member about an offset axis of rotation opposite to an axis of extension of the rod of the hydraulic cylinder with respect to a longitudinal axis of the upper beam.

This feature makes it possible to reduce the footprint produced by the hydraulic cylinder above the deformable parallelogram by moving it back towards the upper beam.

Preferably, the anchor point is located at least beyond one third of the length of the upper beam from the front end of the upper beam.

This increases the absorption of force by the hydraulic cylinder.

According to a preferred design, the connecting member comprises two cheeks between which the front end of the upper beam and a base of the body of the hydraulic cylinder are inserted.

This contributes to the compactness of the means used to raise the deformable parallelogram.

Preferably, the hydraulic cylinder has a cradle on which the base of the cylinder body is fixedly mounted, the cradle being mounted tilting about the axis of rotation offset on the cheeks.

An aspect of the disclosure also relates to a hoeing assembly, characterized in that it comprises a plurality of hoeing devices as described above, the hoeing devices sharing a single frame, the deformable parallelograms of each hoeing device extending in planes parallel to each other, the hydraulic cylinder of each hoeing device being actuatable independently of the cylinder(s) of the other hoeing devices.

Thanks to this hoeing assembly, it is possible to raise the hoeing tools of only one part of the hoeing devices, depending on the needs relating to the terrain on which the vehicle is operating.

For example, when approaching an edge of the terrain, the vehicle user can control the raising of the hoeing devices that must travel at the edge, while leaving the others in the ground to perform hoeing. In this case, the user does not necessarily have to change the route of their vehicle to avoid such an edge.

An aspect of the disclosure also relates to an agricultural vehicle, characterized in that it carries a hoeing device as described previously.

### BRIEF DESCRIPTION OF THE DRAWINGS

Other features and advantages of the aspects of the disclosure will become apparent upon reading the following description of different aspect of the disclosure, given as illustrative and non-limiting examples, and from the appended drawings, including:

FIG. 1 is a schematic representation in perspective of a hoeing device according to an aspect of the disclosure;

FIG. 2 is a schematic representation in a median longitudinal section of a frame, of the connecting member, and of the deformable parallelogram of the hoeing device according to an aspect of the disclosure.

### DETAILED DESCRIPTION

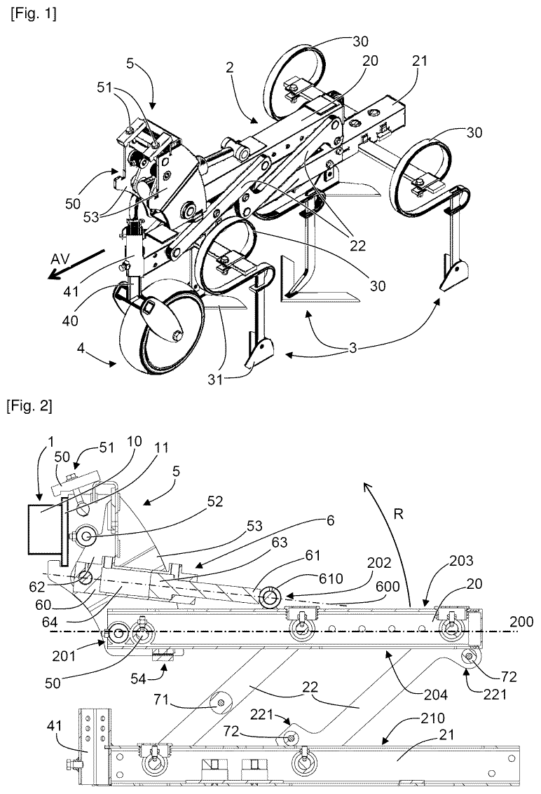

With reference to FIG. 1, a hoeing device according to an aspect of the disclosure is shown.

This hoeing device is intended to be towed by a vehicle.

With reference to FIG. 2, the hoeing device comprises a frame 1, capable of being coupled to a vehicle such as an agricultural tractor.

For this purpose, the frame 1 has an intermediate support 10 taking for example the form of a beam extending transversely to a longitudinal axis of the hoeing device, and a plate 11 coupled to the intermediate support.

As detailed hereinafter, at least part of the remainder of the hoeing device is coupled to the frame 1 in order to be able to be towed, and to perform the hoeing work, by the vehicle.

As discussed hereinafter, several hoeing devices may be combined to form a hoeing assembly. In this case, the frame 1 is shared, and forms a single frame. The frame 1 then has a plurality of plates 11 distributed along the intermediate support 10.

The hoeing device also comprises:
a deformable parallelogram 2;
a member 5 connecting the deformable parallelogram 2 to the frame 1;
a double-acting hydraulic cylinder 6.

With reference to FIGS. 1 and 2, this connecting member 5 is inserted between the frame 1 and the deformable parallelogram 2. The connecting member 5 is designed to ensure the transmission of the traction force from the frame 1 to the deformable parallelogram, but also to enable a raising R of the deformable parallelogram 2 with respect to the frame 1 in cooperation with the double-acting hydraulic cylinder 6.

The deformable parallelogram 2 consists of an assembly comprising:
an upper beam 20;
a lower beam 21;
at least one pair of connecting rods 22, and in particular two pairs of connecting rods located on either side of the beams, the connecting rods each being hingedly connected by one of its ends to the upper beam 20 and, by the other of its ends, to the lower beam 21.

As shown in FIG. 1, the lower beam 21 carries:
a plurality of hoeing tools 3;
a ground running element, such as a wheel, for the hoeing device to run on the ground.

In an exemplary aspect of the disclosure, the ground running element includes a depth-control wheel 4 carried by a height-adjustable arm 40 inserted in a sleeve 41 secured to the deformable parallelogram 2 in the front part thereof, extending from the lower beam 21 so as to position the depth-control wheel 4 substantially vertical to the frame 1 according to the present embodiment.

According to a preferred embodiment, the hoeing tools consist of tines 31 present at the end of elastically deformable members 30 taking the form of an S. These S-shaped members are of a known type and make it possible to generate a vibration phenomenon at the level of the tine in the ground.

The hoeing device may have a series of hoeing tools, the number of which may vary as needed.

According to one embodiment illustrated by FIG. 1, the device carries five hoeing tools, one of which is positioned in line with the beams of the deformable parallelogram, while the others are each carried by an arm 30, so as to offset the hoeing tools laterally with respect to the aligned tine.

The deformable parallelogram 2 of the device is made up as follows: the connecting rods 22 extend from one beam to the other while being inclined forward according to the direction of forward movement AV of the device (or in other words in the direction of the device frame), this from the upper beam 20 to the lower beam 21. As a result, each connecting rod 22 has a rear end hinged on the upper beam 20 and a front end hinged on the lower beam 21.

Thus, with a device according to an aspect of the disclosure, starting from a configuration such as that illustrated by FIG. 1 in which the upper beam and the lower beam have a base spacing between them corresponding to a depth of the hoeing tools in the ground (and in which the tines occupy a position in height below the level of the depth-control wheel 4), when the device moves on hard ground and/or encounters an obstacle (of a nature to cause the phenomenon described below), the elements of the device will react as follows:
the depth-control wheel will maintain or even increase its contact with the ground surface, keeping the lower beam of the parallelogram at a predetermined height;
the resistance exerted on the tine(s) of the hoeing tools will cause the lower beam to tilt towards the rear of the device (the connecting rods 22 pivoting about their hinge on the upper beam, describing at their hinge on the lower beam an arc of circle towards the rear of the device), resulting in an “opening” of the deformable parallelogram tending to lower the lower beam with respect to the upper beam;

This means that the tines of the hoeing tools are kept at the desired depth in the ground, or even slightly increased in the event of hard ground or obstacles in the ground.

With reference to FIG. 2, the hoeing device comprises stops for moving the upper beam 20 relative to the lower beam 21.

The travel stops include:
a first stop 71 carried along the connecting rods 22 located towards the front of the device;
two second stops 72 supported by the other connecting rods 22 located towards the rear of the device.

The first stop 71 takes the form of a cylinder extending longitudinally between the two central portions of the front connecting rods 22 located on either side of the deformable parallelogram 2.

The second stops 72 are supported by hook-shaped ends 221 of the rear connecting rods 22. These rear connecting rods 22 in fact have an S-shaped profile with hook-shaped ends 221 oriented towards the inside of the deformable parallelogram 2.

Similarly, the first stop 71 and the two second stops 72 extend longitudinally respectively between the hook-shaped ends 221 of the two rear connecting rods coupled to the upper beam 20, and between the hook-shaped ends 221 of the two rear connecting rods coupled to the lower beam 21.

In the configuration of maximum spacing of the two beams with respect to one another illustrated in FIG. 2, the upper face 210 of the lower beam is abutting against the second stop 72 carried between the hook-shaped ends 221 coupled to the lower beam of the rear connecting rods, while the lower face 204 of the upper beam 20 is abutting against the second stop 72 carried between the hook-shaped ends 221 coupled to the upper beam 20 of the rear connecting rods.

In the configuration of the two beams folded against one another, all the stops, in particular the first stop 71 and the second stops 72, are then in contact with the lower face 204 of the upper beam 20 and the upper face 210 of the lower beam 21.

The connecting member 5, and more generally the connection of the deformable parallelogram 2 to the frame 1, are described hereinafter with reference to FIGS. 1 and 2.

The connecting member 5 comprises a jaw 50 intended to be closed on the plate 11. To do this, bolts 51 make it possible to clamp one of the claws of the jaw 50 towards another claw which is secured on the connecting member.

The connecting member 5 comprises two cheeks 53.

These two cheeks 53 extend parallel to one another. The jaw 50 is partially formed by these two cheeks 53. The two cheeks 53 serve as a support for the deformable parallelogram 2 and for the double-acting hydraulic cylinder 6.

As mentioned previously, the deformable parallelogram 2 is liftable on the frame 1.

This is because the upper beam 20 is movable with respect to the frame 1 between a position raised towards the frame 1 and a position lowered towards the ground (position illustrated in FIG. 2).

More precisely, the upper beam 20 is rotatably mounted on the connecting member 5 about an axis of rotation 50.

This axis of rotation 50 is carried by the two cheeks 53 of the connecting member 5.

The axis of rotation 50 extends orthogonally to a longitudinal axis 200 of the upper beam 20 and located at a front end 201 of the upper beam 20. The front end 201 of the upper beam 20 corresponds to the end of the upper beam located closest to the connecting member 5.

This axis of rotation 50 extends in particular perpendicularly to the two cheeks 53. This is because the front end 201 of the upper beam 20 is inserted between the two cheeks 53.

As mentioned previously, the hoeing device comprises a double-acting hydraulic cylinder 6.

The hydraulic cylinder 6 comprises:
a body 60;
a rod 61 slidably mounted in the body 60, along an extension axis 500 of the rod 61;
a piston 63 mounted in a cylindrical housing provided in the body 60 and integral with the rod 61.

The hydraulic cylinder has two supply orifices located at the ends of the cylindrical housing. The piston 63 forms two chambers 64 in the cylindrical housing and each supply orifice emerges in one of the two chambers.

Depending on the working direction selected, a liquid is fed into one of the two chambers 64 in order to push back the piston 63. In the position illustrated in FIG. 2, the chamber 64 behind the piston 63 with respect to the rod 61 is fully supplied and the piston 63 and the rod 61 are fully pushed back, the hydraulic cylinder being then in an extended position.

The body 60 is rotatably mounted on the connecting member 5.

More specifically, the hydraulic cylinder 6 has a cradle 62 on which the base 60 of the cylinder body 60 is fixedly mounted.

This cradle 62 extends orthogonally to the extension axis 600 of the rod 61 from the cylinder body 60, up to an end through which the cradle 62 is tilt-mounted on the two cheeks 53. The base of the cylinder body 60 and the cradle 62 are inserted between the two cheeks 53.

The cradle 62 extends in particular orthogonally to the extension axis 600 opposite the deformable parallelogram 2 with respect to the extension axis 600 of the rod 61.

At a distal part of the base of the cylinder body 60, the cradle 62 is thus mounted tilting via an offset axis of rotation 52 on the cheeks 53.

More generally, the hydraulic cylinder 6 is rotatably mounted on the connecting member 5 about the offset axis of rotation 52 which is located opposite the extension axis 600 of the rod 61 of the hydraulic cylinder 6 with respect to the longitudinal axis 200 of the upper beam 20.

The rod 61 of the hydraulic cylinder 6 in turn has a distal end 610 by which the hydraulic cylinder is coupled to the upper beam 20.

In particular, the distal end 610 is rotatably mounted on an anchor point 202 of the upper beam 20.

This anchor point 202 is carried on an upper face 203 of the upper beam 20.

The anchor point 202 is located along the upper beam 20, away from the front end 201 of the upper beam 20.

Thanks to this design, the hydraulic cylinder 6 is in the extended position in the lowered position of the upper beam 20.

As illustrated, the anchor point 202 is located at least beyond one third of the length of the upper beam 20 from the front end 201 of the upper beam 20, and preferentially before half of the length of the upper beam 20.

This configuration optimizes the load-absorption capacity offered by the double-acting hydraulic cylinder 6 in order to counterbalance the forces resulting from hoeing and which are transmitted in the deformable parallelogram 2, the lifting kinematics R of the upper beam 20, while limiting the footprint of the hydraulic cylinder 6.

Furthermore, the connecting member 5 has an end-of-travel stop 54 at its lower end. This end-of-travel stop extends between the two cheeks 53 and has a flat surface against which the lower face 204 of the upper beam 20 abuts in the lowered position of the upper beam 20. This end-of-travel stop 54 acts in synergy with the hydraulic cylinder 6 to hold the upper beam 20 in its lowered position.

As discussed previously, a hoeing assembly may be formed using a plurality of hoeing devices. In this case, the deformable parallelograms of the hoeing devices all extend parallel to each other. In addition, the hydraulic cylinder 6 of each hoeing device is operable independently of the hydraulic cylinders 6 of the other hoeing devices.

A control system thus makes it possible to select the deformable parallelograms to be lifted in order to perform partial hoeing under the hoeing assembly.

An aspect of the disclosure also relates to the vehicle that tows a hoeing device as described previously, or that tows a hoeing assembly.

The hydraulic cylinder(s) 6 described above are intended to be connected to a hydraulic circuit of a vehicle towing the hoeing device. Nevertheless, it is conceivable that the hoeing device, or the hoeing assembly, carries its own hydraulic circuit integrating a hydraulic motor and means for controlling the supply of pressurized fluid to the hydraulic cylinders 6.

The hoeing device described above forms a fundamentally robust and easy-to-maintain solution, while having the ability to at least partially limit a hoeing performed without having to modify the movement of a vehicle towing the hoeing device.

According to an application example, an agricultural tractor-type vehicle can tow a hoeing assembly having more than a dozen hoeing devices. If the vehicle passes near a telling edge forming part of the volume covered by the hoeing assembly, the hoeing devices located at the edge can be raised as soon as they reach the edge and then lowered as soon as the edge is passed. This allows the agricultural tractor to continue driving straight ahead. Raising and lowering of the hoeing devices can be carried out by means of a manual control, but also by means of an automation system which can, for example, integrate a plan indicating the areas not to be hoed and a geolocation of the vehicle.

An exemplary aspect of the present disclosure meets the needs described with respect to the prior art.

An exemplary aspect provides a hoeing device having a good ability to maintain or even reinforce the holding of the hoeing elements in the ground, and the ability not to perform hoeing using the hoeing tools carried by a deformable parallelogram without having to divert the vehicle equipped with the hoeing device.

An exemplary aspect provides such a device that is robust and simple in order to minimize the maintenance necessary to keep it operational.

Although the present disclosure has been described with reference to one or more examples, workers skilled in the art will recognize that changes may be made in form and detail without departing from the scope of the disclosure and/or the appended claims.

1. A hoeing device comprising:
a frame to be coupled to a vehicle for towing the hoeing device;
a deformable parallelogram comprising an upper beam and a lower beam carrying at least one hoeing tool as well as a ground running element for running on the ground, said beams being connected by at least one pair of connecting rods, the connecting rods extending from one beam to the other while being inclined, from the upper beam to the lower beam, forwards in a forward direction of movement of the hoeing device,
a connecting member being inserted between the frame and the deformable parallelogram;
the upper beam being movable relative to the frame between a position raised towards the frame and a position lowered towards the ground,
the upper beam being rotatably mounted on the connecting member about an axis of rotation extending orthogonally to a longitudinal axis of the upper beam and located at a front end of the upper beam; and
a double-acting hydraulic cylinder comprising a body rotatably mounted on the connecting member and a rod whose distal end is rotatably mounted on an anchor point of the upper beam, the anchor point being located along the upper beam and away from the front end of the upper beam, the hydraulic cylinder being in an extended position in the lowered position of the upper beam.

2. The hoeing device according to claim 1, wherein the hydraulic cylinder is rotatably mounted on the connecting member about an offset axis of rotation opposite an extension axis of the rod of the hydraulic cylinder with respect to the longitudinal axis of the upper beam.

3. The hoeing device according to claim 2, wherein the anchor point is located at least beyond one third of a length of the upper beam from the front end of the upper beam.

4. The hoeing device according to claim 1, wherein the connecting member comprises first and second cheeks between which the front end of the upper beam and a base of the body of the hydraulic cylinder are inserted.

5. The hoeing device according to claim 4, wherein:
the hydraulic cylinder is rotatably mounted on the connecting member about an offset axis of rotation opposite an extension axis of the rod of the hydraulic cylinder with respect to the longitudinal axis of the upper beam; and
the hydraulic cylinder has a cradle on which the base of the cylinder body is fixedly mounted, the cradle being mounted tilting about the offset axis of rotation on the first and second cheeks.

6. A hoeing assembly comprising:
a plurality of hoeing devices, wherein each of the plurality of hoeing devices comprises:
a frame to be coupled to a vehicle for towing the hoeing device;
a deformable parallelogram comprising an upper beam and a lower beam carrying at least one hoeing tool as well as a ground running element for running on the ground, said beams being connected by at least one pair of connecting rods, the connecting rods extending from one beam to the other while being inclined, from the upper beam to the lower beam, forwards in a forward direction of movement of the hoeing device,
a connecting member being inserted between the frame and the deformable parallelogram;
the upper beam being movable relative to the frame between a position raised towards the frame and a position lowered towards the ground,
the upper beam being rotatably mounted on the connecting member about an axis of rotation extending orthogonally to a longitudinal axis of the upper beam and located at a front end of the upper beam; and
a double-acting hydraulic cylinder comprising a body rotatably mounted on the connecting member and a rod whose distal end is rotatably mounted on an anchor point of the upper beam, the anchor point being located along the upper beam and away from the front end of the upper beam, the hydraulic cylinder being in an extended position in the lowered position of the upper beam,
wherein the frame of each of the hoeing devices is a single frame shared among the plurality of hoeing devices, the deformable parallelograms of the plurality of hoeing devices extend in planes parallel to each other, the hydraulic cylinder of at least one of the plurality of hoeing devices is operable independently of the hydraulic cylinders of at least one other of the hoeing devices.

7. An agricultural vehicle comprising:
a hoeing device carried by the vehicle and comprising:
a frame;
a deformable parallelogram comprising an upper beam and a lower beam carrying at least one hoeing tool as well as a ground running element for running on the ground, said beams being connected by at least one pair of connecting rods, the connecting rods extending from one beam to the other while being inclined, from the upper beam to the lower beam, forwards in a forward direction of movement of the hoeing device,
a connecting member being inserted between the frame and the deformable parallelogram;
the upper beam being movable relative to the frame between a position raised towards the frame and a position lowered towards the ground,
the upper beam being rotatably mounted on the connecting member about an axis of rotation extending orthogonally to a longitudinal axis of the upper beam and located at a front end of the upper beam; and
a double-acting hydraulic cylinder comprising a body rotatably mounted on the connecting member and a rod whose distal end is rotatably mounted on an anchor point of the upper beam, the anchor point being located along the upper beam and away from the front end of the upper beam, the hydraulic cylinder being in an extended position in the lowered position of the upper beam.
